(19) United States
(12) Patent Application Publication
(10) Pub. No.: US 2016/0224922 A1
(43) Pub. Date: Aug. 4, 2016

(54) SYSTEM AND METHOD FOR EVALUATING PERFORMANCE OF INFRASTRUCTURE

(71) Applicant: KOREA INSTITUTE OF CIVIL ENGINEERING AND BUILDING TECHNOLOGY, Gyeonggi-do (KR)

(72) Inventors: Myung Jin CHAE, Seoul (KR); Tae Il PARK, Seoul (KR)

(73) Assignee: KOREA INSTITUTE OF CIVIL ENGINEERING AND BUILDING TECHNOLOGY, Gyeonggi-do (KR)

(21) Appl. No.: 15/008,454

(22) Filed: Jan. 28, 2016

(30) Foreign Application Priority Data
Feb. 2, 2015 (KR) 10-2015-0015894

(51) Int. Cl. G06Q 10/06

(52) U.S. Cl. CPC G06Q 10/06393

(57) ABSTRACT

Disclosed herein are a system and method for evaluating the performance of infrastructure, in which a condition rating according to a result of a survey targeting experts is expressed as a sequentially distributed probability distribution function using a fuzzy membership function and a comprehensive performance measure score is more accurately expressed as a probability distribution function, thereby accurately evaluating a comprehensive performance measure rating. Also, a utility value is derived using a utility function and usable and functional evaluation measures for each facility of the infrastructure are collected, thereby comprehensively determining subjective performance evaluation measures of the infrastructure.

### CROSS-REFERENCE TO RELATED APPLICATION

This application claims priority to and the benefit of Korean Patent Application No. 10-2015-0015894, filed on Feb. 2, 2015, the disclosure of which is incorporated herein by reference in its entirety.

1. Technical Field

Embodiments of the present invention relate to a performance evaluation of infrastructure, and more particularly, to a system and method for evaluating the performance of infrastructure, which evaluate a facility performance rating (facility performance measure) and estimate a comprehensive performance rating for each facility (comprehensive performance measure for each facility) to evaluate the performance of infrastructure.

2. Background Art

Generally, even though the concept of asset management for infrastructure or public facilities has been present for a long time, since sizes of such structure and facilities increase and a large-scale developmental generation has passed, only the feasibility of development has been considered but an aggressive effort for management of a built structure and facilities is insufficient. A budget for maintaining and managing such infrastructure or public facilities has rapidly increased and a related data processing technology has been developed due to information technology. Accordingly, integrated management of such infrastructure or public facilities is available and asset management thereof becomes detailed.

Domestically, as of 2009, the present Ministry of Strategy and Finance is leading actual inspections for infrastructure, which is a previous stage that may be a basic stage of a method of checking a present condition of infrastructure and evaluating an appropriate level of an asset value of infrastructure. A definition of such infrastructure indicates assets which have been built with large-scale investment to form national infrastructure and economic effects thereof have appeared over a long period of time. For example, facilities of infrastructure may be classified into eight types such as roads, railroads, harbors, dams, airports, water supplies, rivers, and fishing ports and may be detailed as shown in FIG. 1 according to National Accounting Act 14.

FIG. 1 is a view illustrating generally classified facilities of infrastructure, and FIG. 2 is a schematic diagram illustrating asset management of each facility of infrastructure according to a conventional technology.

Referring to FIG. 2, facilities of infrastructure 10 according to a conventional technology are divided into a road 11, a railway 12, a harbor 13, a dam 14, an airport 15, a water supply 16, a river 17, and a fishing port 18, in which the respective facilities 11 to 18 of infrastructure have been separately managed by respective asset management systems 21 to 28.

Meanwhile, according to the Special Act on the Safety Control of Public Structures as an example of domestic reports related to existing overall performance evaluation with respect to infrastructure, social infrastructure which was built before 30 years ago reaches about 11% (1,898/17,513). For example, in domestic cases, as a result of infrastructure management authority safety and maintenance fact finding research performed under the jurisdiction of the Ministry of Land, Transport and Maritime Affairs (current Ministry of Land, Subject: Safety Facility Management and Maintenance Survey (Korea Infrastructure Safety Authority, 2010)), it was reported that the deterioration of SOC has progressed and needs for accurate estimation and maintenance thereof has increased. Particularly, it has been reported that due to a construction boom which has started in the 1970s, facilities more than 30 years old may increase twofold in 10 years.

Meanwhile, all over the world, investment in infrastructure focuses on maintenance and management rather than new infrastructure. For effective safety and maintenance of facilities, it is necessary to efficiently execute investment of a budget based on a highly reliable performance evaluation through objective, comprehensive, and quantitative evaluation of the facilities.

Existing infrastructure performance evaluations generally depend on visual checks. Particularly, since it is limited to safety and durability, various performance elements of facilities, such as usability, functionality, etc. are not considered and any grounds for a method of setting weights for a comprehensive determination are not provided.

Accordingly, to comprehensively consider performance of various facilities of infrastructure and to perform improved performance-based management, it is necessary to develop comprehensive performance evaluation indicators for each type of the facilities of the infrastructure and a performance monitoring system through developing an implementable program.

Also, since usability, functional measures, etc. for each facility of infrastructure are subjective evaluation indicators, it is necessary to develop a mathematical analysis model for mathematically converting subjective measures. Also, it is necessary to develop a method of determining a weight for a measure of each facility of the infrastructure and a statistical method for removing bias in evaluation indicators, which exists for each measure during a process of integrating measures.

[Patent Document 1] Korean Patent Registration No. 10-1429219 (Jun. 27, 2012), titled “Decision Making System for Cross Asset Management of Infrastructure”.

[Patent Document 2] Korean Patent Registration No. 10-0606861 (Jul. 16, 2004), titled “Infrastructure Maintenance and Management Business Support System, the Method Using the Same”.

[Patent Document 3] Korean Patent Registration No. 10-0760625 (Jan. 18, 2005), titled “Facility Management System”.

[Patent Document 4] Korean Patent Registration No. 10-0748078 (Apr. 5, 2006), titled “The Methodology of Optimum Maintenance Strategy for Infrastructures based on Life-Cycle Performance and Cost”.

[Patent Document 5] Korean Patent Registration No. 10-1049405 (Nov. 3, 2009), titled “System for Managing Asset of Bridge”.

[Patent Document 6] Korean Patent Publication No. 10-2010-0076708 (Jul. 6, 2010), titled “Asset Management Information System for Social Infrastructures”.

[Patent Document 7] Korean Patent Publication No. 10-2009-072223 (Jul. 2, 2009), titled “Methodology of Network Level Optimum Management System for Infrastructures based on Life Cycle Performance and Cost”.

### SUMMARY

The present invention is directed to a system and method for evaluating the performance of infrastructure, in which a condition rating according to a result of a survey targeting experts is expressed as a sequentially distributed probability distribution function using a fuzzy membership function and a comprehensive performance measure score is more accurately expressed as a probability distribution function, thereby accurately evaluating a comprehensive performance measure rating.

The present invention is also directed to a system and method for evaluating the performance of infrastructure, in which a utility value is derived using a utility function and usable and functional evaluation measures for each facility of infrastructure are collected, thereby comprehensively determining subjective performance evaluation measures of infrastructure.

According to an aspect of the present invention, there is provided a system for evaluating the performance of infrastructure which includes roads, railways, harbors, dams, bridges, airports, rivers, water supplies, and fishing ports. The system includes a comprehensive facility performance measure setting unit which selects a comprehensive performance measure for each facility, which is defined according to customer value items preset for each facility of the infrastructure, a facility performance measure setting unit which defines a facility performance measure which quantitatively indicates the comprehensive facility performance measure for each facility of the infrastructure using a fuzzy membership function according to properties of the comprehensive facility performance measure, a facility performance measure utility function determination unit which determines a utility function for each facility performance measure corresponding to an effect value selectively given within a range from 0% to 100% utilizing an expert survey through normalization using a utility theory, a facility performance measure weight determination unit which assigns a weight for each facility performance measure using an analytic hierarchy process (AHP), a facility performance measure evaluation unit which evaluates the facility performance measure utilizing an on-site survey or a check result, a facility performance measure utility function determination unit which determines a utility value for each facility performance measure using the determined facility performance measure utility function and the assigned weight, a facility comprehensive performance measure score calculation unit which calculates a facility comprehensive performance measure score for each facility of the infrastructure, a facility comprehensive performance measure evaluation result analysis unit which analyzes an evaluation result by analyzing an effect of the facility performance measure on the facility comprehensive performance measure score, and an infrastructure performance evaluation unit which performs a comprehensive performance evaluation for each facility of the infrastructure. Here, the facility performance measure setting unit expresses a condition rating according to a result of the expert survey using the fuzzy membership function as a sequentially distributed probability distribution function, and corresponding thereto, the facility comprehensive performance measure is expressed as a probability distribution function in the form of a fuzzy membership function.

According to another aspect of the present invention, there is provided a method of evaluating the performance of infrastructure which includes roads, railways, harbors, dams, bridges, airports, rivers, water supplies, and fishing ports. The method includes a) selecting a comprehensive performance measure for each facility, which is defined according to customer value items preset for each facility of the infrastructure, b) defining a facility performance measure which quantitatively indicates the comprehensive facility performance measure for each facility of the infrastructure using a fuzzy membership function according to properties of the comprehensive facility performance measure, c) determining a weight for each facility performance measure using an AHP, d) determining a utility function for each facility performance measure corresponding to an effect value selectively given within a range from 0% to 100% utilizing an expert survey through normalization using a utility theory, e) evaluating the facility performance measure utilizing an on-site survey or a check result, f) determining a utility value for each facility performance measure using the determined facility performance measure utility function and the determined weight, g) calculating a facility comprehensive performance measure score for each facility of the infrastructure, h) analyzing an evaluation result by analyzing an effect of the facility performance measure on the facility comprehensive performance measure score, and i) performing a comprehensive performance evaluation for each facility of the infrastructure. Here, in operation b), a condition rating according to a result of the expert survey is expressed using the fuzzy membership function as a sequentially distributed probability distribution function, and corresponding thereto, the comprehensive performance measure for each facility is expressed as a probability distribution function in the form of a fuzzy membership function.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating generally classified facilities of infrastructure;

FIG. 2 is a schematic diagram illustrating asset management of each facility of infrastructure according to the prior art;

FIG. 3 is a schematic diagram of a decision making system for cross asset management of infrastructure;

FIG. 4 is a diagram illustrating a strategy of promoting the introduction of an infrastructure asset management system;

FIG. 5 is a view illustrating an expert evaluation result shown in numbers;

evaluation level which is applied to an infrastructure performance evaluation system according to one embodiment of the present invention;

FIG. 7 is a view illustrating a fuzzy membership function with a strengthened central score which is applied to the infrastructure performance evaluation system according to one embodiment of the present invention;

FIG. 8 is a configuration diagram of the infrastructure performance evaluation system according to one embodiment of the present invention;

FIG. 9 is a flowchart illustrating a method of evaluating the performance of infrastructure according to the one embodiment of the present invention;

FIG. 10 is a detailed flowchart illustrating the method of evaluating the performance of infrastructure according to one embodiment of the present invention;

FIG. 11 is a view illustrating a definition of a customer value item when a facility of infrastructure is a bridge in the infrastructure performance evaluation system according to a detailed embodiment of the present invention;

FIG. 12 is a view illustrating facility performance measures according to comprehensive facility performance measures when the facility of infrastructure is the bridge in the infrastructure performance evaluation system according to the detailed embodiment of the present invention;

FIGS. 13a and 13b are views illustrating standards for determining of facility performance measures according to comprehensive facility performance measures when the facility of infrastructure is the bridge in the infrastructure performance evaluation system according to the detailed embodiment of the present invention;

FIG. 14 is a view illustrating weights for facility performance measures when the facility of infrastructure is the bridge in the infrastructure performance evaluation system according to the detailed embodiment of the present invention;

FIG. 15 is a view illustrating a result of a survey for determining a utility function when the facility of infrastructure is the bridge in the infrastructure performance evaluation system according to the detailed embodiment of the present invention;

FIG. 16 is a view illustrating comprehensive performance measure scores (effective values) for each of facilities according to comprehensive performance measure ratings for each facility of infrastructure when the facility of infrastructure is the bridge in the infrastructure performance evaluation system according to the detailed embodiment of the present invention;

FIGS. 17a to 17d are views illustrating utility values of facility performance measures when the facility of infrastructure is the bridge in the infrastructure performance evaluation system according to one embodiment of the present invention, respectively;

FIGS. 18a to 18b are views illustrating questionnaires for determining weights when the facility of infrastructure is the bridge in the infrastructure performance evaluation system according to one embodiment of the present invention, respectively; and

FIG. 19 is a view illustrating a result of a survey for determining weights when the facility of infrastructure is the bridge in the infrastructure performance evaluation system according to one embodiment of the present invention.

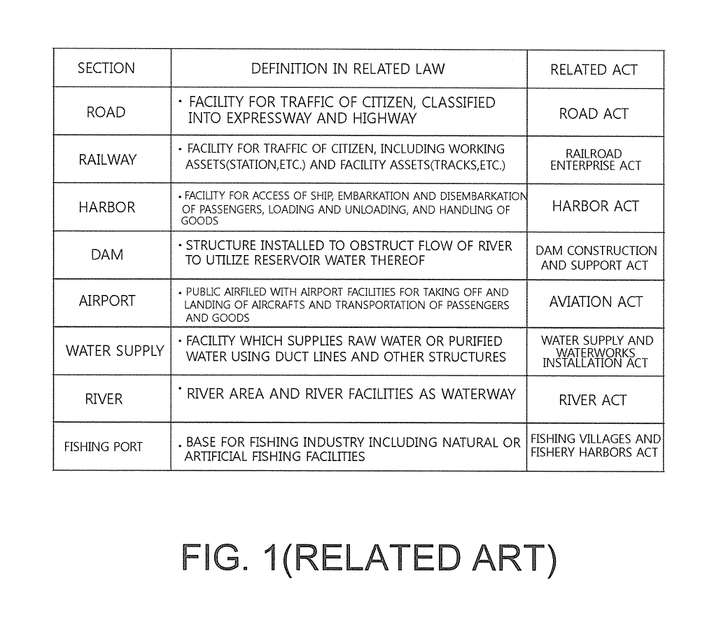

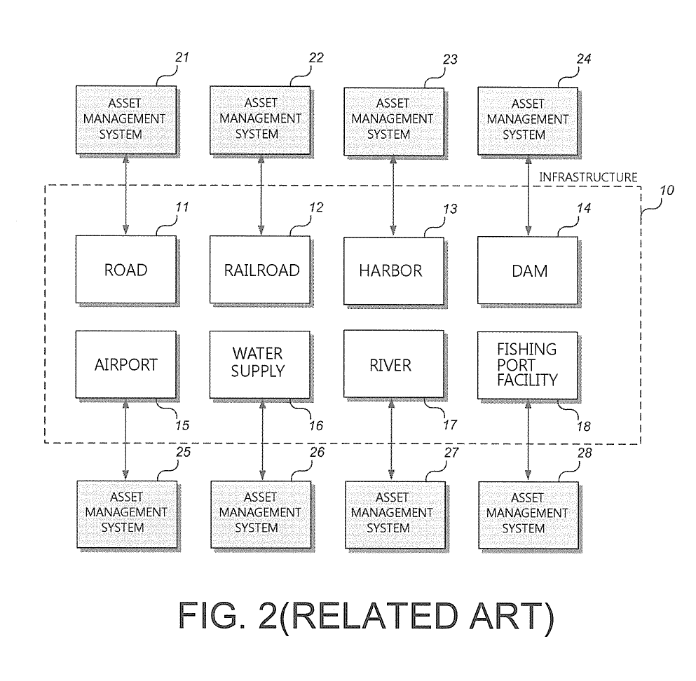

### DETAILED DESCRIPTION OF THE EMBODIMENTS

Hereinafter, embodiments of the present invention will be described in detail with reference to the attached drawings, to allow one of ordinary skilled in the art to easily execute. However, the present invention may be provided in various different forms and is not limited to the embodiments described herein. Also, in the drawings, in order to clearly describe the embodiments, an irrelevant part will be omitted. Throughout the specification, like reference numerals refer to like elements.

Also, throughout the specification, when it is described that a part “comprises” an element, unless the context clearly indicates otherwise, this means that the part do not exclude other elements but may further include other elements.

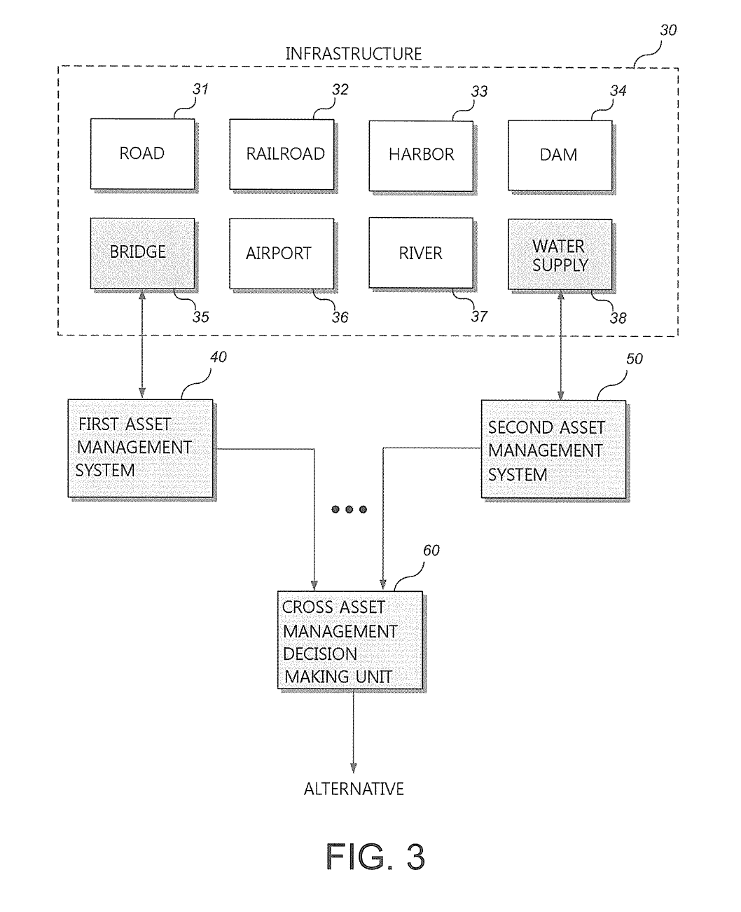

First, as prior art, Korean Patent Registration No. 10-1429219, filed by the applicant of the present invention, discloses “Decision Making System for Cross Asset Management of Infrastructure”, which is referred to in the specification to form part of the present invention and will be described with reference to FIG. 3.

FIG. 3 is a schematic diagram of a decision making system for cross asset management of infrastructure.

Referring to FIG. 3, the decision making system for cross asset management of infrastructure may include infrastructure 30, a first asset management system 40, a second asset management system 50, and a cross asset management decision making unit 60. Here, the infrastructure 30 may include a plurality of different facilities 31 to 38.

The infrastructure 30 may include a road 31, a railway 32, a harbor 33, a dam 34, a bridge 35, an airport 36, a river 37, and a water supply 38 but is not limited thereto. The decision making system for cross asset management of infrastructure according to a conventional technology makes a decision for cross asset management of at least two facilities of infrastructure and supports optimal decision making.

The first asset management system 40, for example, is an asset management system for the bridge 35 and the second asset management system 50, for example, is an asset management system for the water supply 38. The first asset management system 40 and the second asset management system 50 define levels of service (LOS) and performance measure (PM) of the different facilities 31 to 38 for each customer value item, determine a utility function for each performance measure, and a utility value for each performance measure depending on weights, evaluate the LOS, respectively, by calculating scores of the LOS to perform asset management for the different facilities 31 to 38.

The cross asset management decision making unit 60 makes a decision for cross asset management of the different facilities of infrastructure 30 according to results of the LOS evaluation performed by the first and second asset management systems 40 and 50, respectively, and supports optimal decision making.

For integrated management of the infrastructure 30, priorities of asset distribution and maintenance activities are to be determined according to mutual priorities quantitatively evaluated through mutual standardization among the different facilities 31 to 38.

Accordingly, respective LOS may be grouped into seven core values classified as customer values, a weight calculation mean may be applied according to importance for each value to evaluate quantitative service quality through normalization among different facilities, and the maintenance priorities and optimal decision making for the different facilities may be supported.

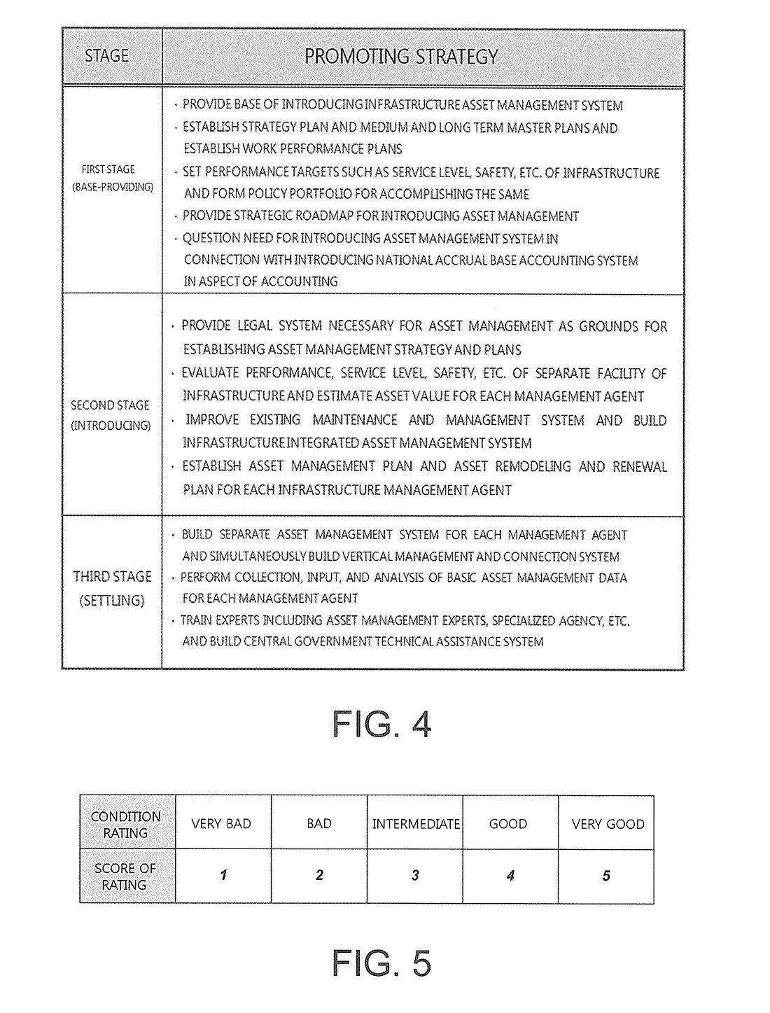

Meanwhile, FIG. 4 is a diagram illustrating a strategy of promoting the introduction of an infrastructure asset management system.

As a comprehensive level evaluation concept among the different facilities, in domestic cases, in an aspect of upgrading a current maintenance and management system to an asset management system, as shown in FIG. 4, to introduce the infrastructure asset management system, three stages of (1) base-providing, (2) introducing, and (3) settling may be provided and a development strategy may be provided for each stage.

Here, a range of targets of the asset management system in (1) the base-providing stage may be facilities in a broad sense including the entire facilities of infrastructure such as roads, bridges, water and sewage, etc. and it is to be provided in (3) the settling stage that management agents for the respective facilities establish separate asset management systems and to present a strategy to construct a vertical management and connected system at the same time.

It is an asset management concept at an upper level of asset management, which is a strategy for introducing asset management for a cross asset management level of management of facilities of national infrastructure. An example of Korean asset management integration framework is also an asset management concept at the upper most level, a target of which is the entire infrastructure.

Meanwhile, a comprehensive performance evaluation of infrastructure integrates condition information, budget information, etc. collected from below, allows the facilities of infrastructure to maintain generally similar function levels based on a quantitatively evaluated coefficient, and ultimately calculates priorities in investment for core management.

For example, when a maintenance and management plan is established according to comprehensive performance measures of the national infrastructure, the Ministry of Strategy and Finance becomes a main agent of infrastructure budget compilation as the uppermost regulatory agency. Actually, budgets for infrastructure, for example, a road, a water resource group, etc. may be assigned according to requests of the Construction and Management Administration or local governments which manage detailed facilities, for example, local roads, bridges, tunnels, water supplies, sewages, etc. under the responsibility of respective administration department heads.

Hereinafter, as described below, a comprehensive facility grade and evaluation process of the infrastructure performance evaluation system according to the embodiment of the present invention may comprehensively determine subjective performance evaluation indicators of several facilities of infrastructure based on the cross asset management described above.

[Calculating of Condition Level Using Fuzzy Membership Function]

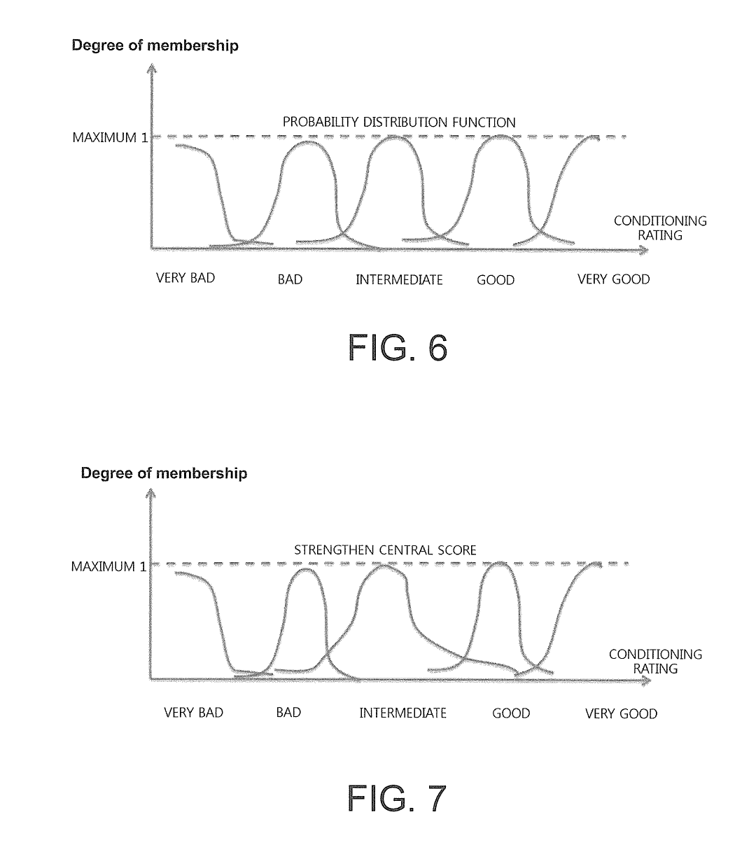

FIG. 5 is a view illustrating an expert evaluation result shown in numbers. FIG. 6 is a view illustrating a fuzzy membership function of a condition evaluation rating which is applied to an infrastructure performance evaluation system according to one embodiment of the present invention. FIG. 7 is a view illustrating a fuzzy membership function with a strengthened central score which is applied to the infrastructure performance evaluation system according to the embodiment of the present invention.

Generally, fuzzy set theory shows a rating of an element being included in a set in a classical set theory as probability. Here, a subjective opinion may be mathematically expressed using a fuzzy membership function. For example, to mathematically express linguistic variables such as “warm” and “hot” in temperature, “warm” may be defined as 25° C. and “hot” may be defined as 30° C., which may be different for each person. Also, precise numerical differentiation may generate an unexpected result when processing an approximate value. For example, when 25° C. is defined as “warm”, this may result in 24.4° C. not being defined as “warm”. Accordingly, to express each linguistic variable as a probability function, “warm” may be assumed as a normal distribution function which has a mean of 25° C. and a standard deviation of 3. To define each linguistic variable as a probability function as described above is referred to as a fuzzy membership function. Accordingly, a temperature of 26° C. may be defined to have a degree of membership about 90% in the fuzzy membership function “warm”, and a temperature of 27° C. may be defined to have a degree of membership about 70% in the fuzzy membership function “warm”.

Accordingly, the fuzzy set theory (or fuzzy logic) may be applied to calculate a comprehensive performance evaluation rating (comprehensive performance measure) of infrastructure according to the embodiment of the present invention. Here, a condition rating according to an expert-survey result may be expressed as a sequentially distributed probability distribution function and not a discontinuous number.

For example, when an expert-evaluation result of a pavement condition of a bridge is shown as five ratings, scores of the five ratings may be defined using a fuzzy membership function. That is, condition ratings are classified into very bad, bad, intermediate, good, and very good and are defined as 1 point, 2 points, 3 points, 4 points, and 5 points, respectively. That is, when the scores of the condition ratings are set respectively in an existing method shown in FIG. 5, very bad may be defined as 1 point and very good may be defined as 5 points. However, the respective scores may not be defined as discontinuous scores such as 1 point, 2 points, etc. but may be defined as a probability distribution function as shown in FIG. 6.

As described above, rating scores shown in numbers such as 1, 2, 3, etc. may be defined N(1,1), N(2,1), etc. using the probability distribution function (generally, a normal distribution function). Here, N(1,1) refers to a normal distribution function which has a mean of 1 and a standard deviation of 1 and N(2,1) refers to a normal distribution function which has a mean of 2 and a standard deviation of 1.

When the fuzzy membership function is used as described above, it is possible to show linguistic variables using a mathematical function. As described above, although crisp numbers (existing numbers) are generally used in a survey result in a typical method, it is not accurate to mathematically consider linguistically expressed items.

For example, actually, experts, particularly those who receive expenses for their consultation while evaluating, generally intend not to give a bad score. Also, when there are no peculiar items, it is natural to have a survey result which gravitates to a center. When such tendency is particularly much shown, as shown in FIG. 7, it may be defined a fuzzy membership function with a strengthened central score.

Accordingly, through definition and adjustment of the fuzzy membership function, subjective opinions in a survey paper may be mathematically modeled. Here, the definition of the fuzzy membership function may be set through a separate survey for researchers or may be made considering score distribution of a survey result. However, since a process of developing the fuzzy membership function is obvious to those skilled in the art, a detailed description thereof will be omitted. Also, when general crisp numbers (existing numbers) are used, it is very simple mathematically to show a sum of scores of items but it needs a complicated process to aggregate evaluation scores (a sum of fuzzy numbers) using the fuzzy membership function. Here, since a detailed calculation process already has been disclosed in “Fuzzy and Neural Approaches in Engineering (Tsoukalas, 1997)”, etc., it will be omitted. Rather, a calculation of a fuzzy membership function may be merely performed using a well-known existing mathematical method.

[Infrastructure Performance Evaluation System 100]

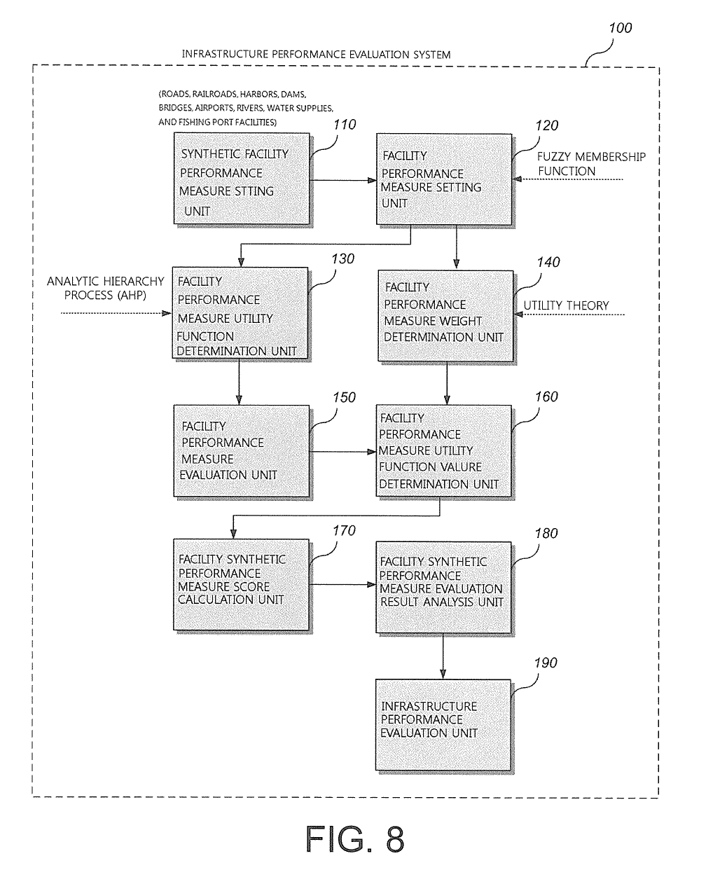

FIG. 8 is a configuration diagram of an infrastructure performance evaluation system according to one embodiment of the present invention.

Referring to FIG. 8, an infrastructure performance evaluation system 100 according to the embodiment of the present invention is a system for evaluating the performance of facilities of infrastructure, which include roads, railways, harbors, dams, bridges, airports, water supplies, and fishing ports, and includes a comprehensive facility performance measure setting unit 110, a facility performance measure setting unit 120, a facility performance measure utility function determination unit 130, a facility performance measure weight determination unit 140, a facility performance measure evaluation unit 150, a facility performance measure utility value determination unit 160, a facility comprehensive performance measure score calculation unit 170, a facility comprehensive performance measure evaluation result analysis unit 180, and an infrastructure performance evaluation unit 190.

The infrastructure performance evaluation system 100 according to the embodiment of the present invention defines a comprehensive facility performance measure and a facility performance measure for each facility of infrastructure selected from a road, a railway, a harbor, a dam, a bridge, an airport, a water supply, and a fishing port, determines a performance measure utility function and a performance measure utility value depending on a weight, and calculates a comprehensive facility performance measure score to evaluate the comprehensive facility performance measures, respectively, thereby performing a comprehensive performance evaluation of the infrastructure.

A utility value is derived using a utility function to normalize the comprehensive facility performance measure among facilities of infrastructure. Here, the performance measure utility function may be determined according to multi-attribute utility theory (MAUT) to integrate facility performance measures with different properties of the comprehensive facility performance measure and to sequence rating standards.

In detail, the comprehensive facility performance measure setting unit 110 selects comprehensive facility performance measures defined according to preset customer value items for each facility of infrastructure. Here, the comprehensive facility performance measure setting unit 110 classifies the customer value items of the facility into sustainability, accessibility, affordability, quality, health & safety, reliability & responsiveness, and customer service and defines respective properties to derive comprehensive facility performance measures.

The facility performance measure setting unit 120 defines the facility performance measures which quantitatively indicate the comprehensive facility performance measures according to properties of the comprehensive facility performance measures using a fuzzy membership function. That is, the facility performance measure setting unit 120 may indicate a condition rating according to an expert survey result as a sequentially distributed probability distribution function using the fuzzy membership function. Corresponding thereto, the comprehensive facility performance measure may be indicated as a probability distribution function in the form of the fuzzy membership function.

The facility performance measure utility function determination unit 130 determines a utility function for each facility performance measure corresponding to an effective value selectively given from a range from 0% to 100% utilizing an expert survey through normalization using a utility theory.

The facility performance measure weight determination unit 140 assigns a weight to each facility performance measure using an analytic hierarchy process (AHP).

The facility performance measure evaluation unit 150 evaluates the facility performance measure utilizing an on-site survey or a check result.

The facility performance measure utility value determination unit 160 determines a utility value for each facility performance measure using the determined facility performance measure utility function and the given weight.

The facility comprehensive performance measure score calculation unit 170 calculates a facility comprehensive performance measure score for each facility of infrastructure.

The facility comprehensive performance measure evaluation result analysis unit 180 may analyze an effect of the facility performance measure on the facility comprehensive performance measure score, may analyze an evaluation result, and may reset a facility performance measure according to a maintenance and management strategy.

Also, the infrastructure performance evaluation unit 190 performs a comprehensive performance evaluation for each facility of infrastructure.

In other words, in the infrastructure performance evaluation system according to the embodiment of the present invention, since the comprehensive facility performance measure score is normalized using the utility value described above, comprehensive facility performance measures for each facility of infrastructure such as a road, a bridge, a water supply, a sewerage system, etc. may be comparatively evaluated using the same. That is, the comprehensive facility performance measure may be shown as a utility value using the utility function and the utility value may be utilized for comparison among facilities of infrastructure.

Here, the utility function, which objectively expresses a subjective determination, mathematically expresses that an orange may be better to one person and an apple may be more important to another person. In the embodiment of the present invention, the utility function is applied to evaluate the performance of infrastructure, thereby providing, for example, mathematical/scientific grounds to determine which is preferentially necessary for citizens in Seoul: to restore roads or to maintain sewer pipes.

After all, in the embodiment, since the infrastructure performance evaluation score derived through a sum of fuzzy membership function as a result also has a shape of a probability distribution function in the form of the fuzzy membership function, a comprehensive performance evaluation score may be more accurately expressed in the probability distribution function.

[Method of Evaluating the Performance of Infrastructure]

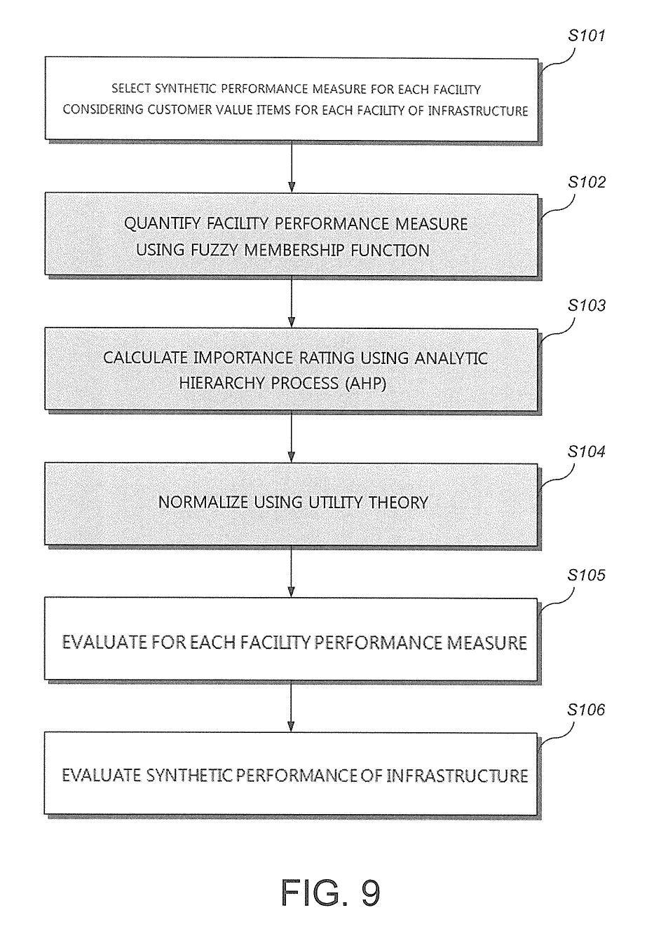

FIG. 9 is a flowchart illustrating a method of evaluating the performance of infrastructure according to the one embodiment of the present invention.

Referring to FIG. 9, the method of evaluating the performance of infrastructure according to the embodiment of the present invention includes, first, selecting a comprehensive facility performance measure for each facility of infrastructure in consideration of customer value items (S101) and quantifying the facility performance measure using a fuzzy membership function (S102).

Next, an importance rating is calculated using an AHP (S103).

Next, normalization is performed using a utility theory (S104).

Next, a facility performance measure evaluation is performed (S105), and then a comprehensive performance evaluation of infrastructure is performed (S106).

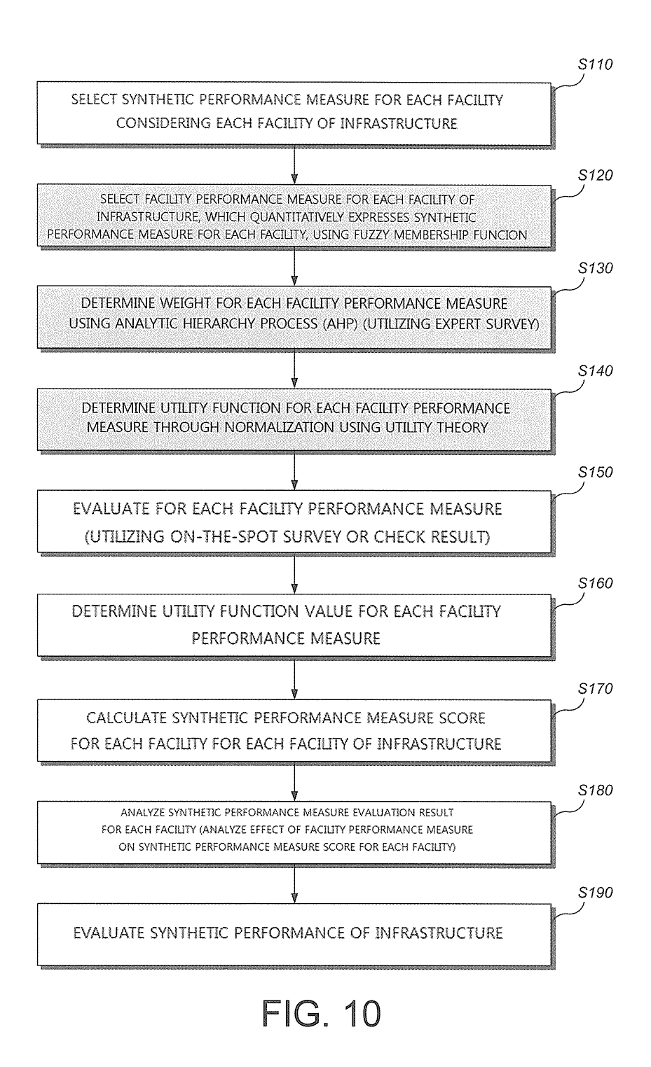

Meanwhile, FIG. 10 is a detailed flowchart illustrating the method of evaluating the performance of infrastructure according to the embodiment of the present invention.

Referring to FIG. 10, the method of evaluating the performance of infrastructure according to the embodiment of the present invention is a method of evaluating the performance of facilities of infrastructure such as a road, a railway, a harbor, a dam, a bridge, an airport, a river, a water supply, and a fishing port. First, a comprehensive facility performance measure which is defined for each facility of infrastructure according to customer value items is selected (S110). Here, the customer value items of the facility are classified into sustainability, accessibility, affordability, quality, health & safety, reliability & responsiveness, and customer services and respective properties are defined to derive ideal comprehensive performance measures for the facility.

Next, a facility performance measure which quantitatively expresses a comprehensive facility performance measure for each facility of infrastructure is selected using a fuzzy membership function (S120).

Next, a weight for each facility performance measure is determined using an AHP (S130). Here, an expert survey and the like are utilized.

Next, a utility function for each facility performance measure is determined through normalization using the utility theory (S140). Here, the performance measure utility function may be determined according to MAUT to integrate facility performance measures with different properties of the comprehensive facility performance measure and to sequence rating standards.

Next, the facility performance measure is evaluated utilizing an on-site survey or a check result (S150).

Next, a utility value for each of the facility performance measures is determined (S160). Here, for normalization among the facilities of infrastructure, the utility value is derived. That is, when it is possible to express an evaluation result for each facility performance measure as a quantified and objective measure, each of the facility performance measures may be derived utilizing the utility function. Here, while the utility function is developed, it is necessary to determine the utility function by fully considering the infrastructure, a target management level thereof, and an opinion of an expert group. Through the process described above, the utility value may be calculated according to a rating according to a facility safety inspection result and a value for each separate facility performance measure may allow a comprehensive facility performance measure value of each facility of infrastructure to be quantitatively derived in consideration of the weight for each performance measure.

Next, a comprehensive facility performance measure score for each of the facilities of infrastructure is calculated (S170).

Next, an effect of the facility performance measure on the comprehensive facility performance measure score is analyzed, thereby analyzing a comprehensive facility performance measure evaluation result for each of the facilities of infrastructure (S180). Here, the effect of the facility performance measure on the comprehensive facility performance measure score may be analyzed and then a facility performance measure according to analysis of the evaluation result and a maintenance and management strategy may be reset. Next, a comprehensive performance evaluation for each facility of the infrastructure is performed (S190).

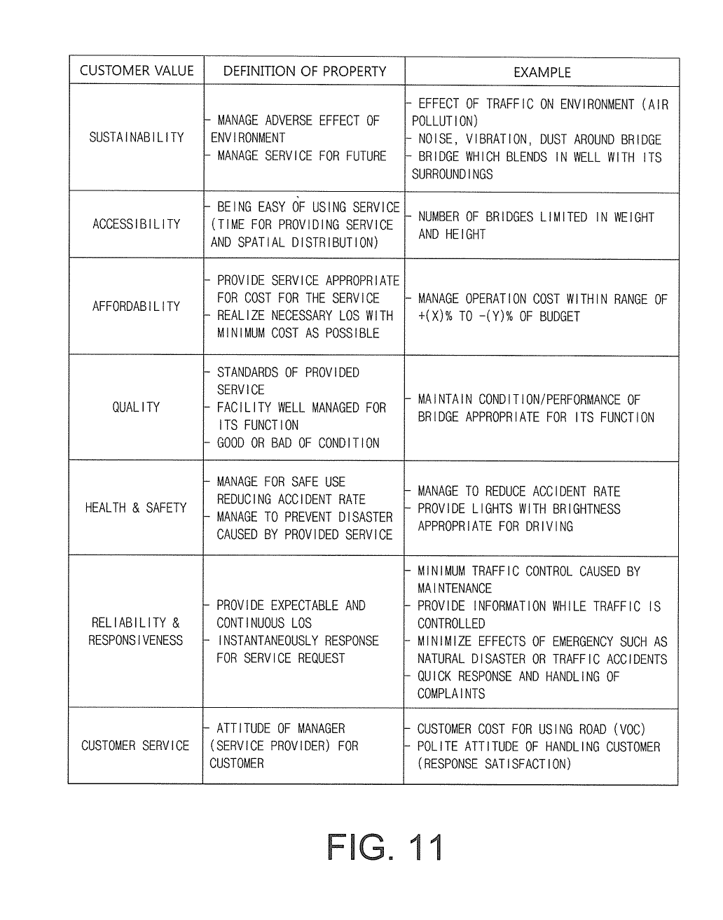

Hereinafter, referring to FIGS. 11 to 19, the infrastructure performance evaluation system according to the embodiment of the present invention will be described in detail.

In the infrastructure performance evaluation system according to the embodiment of the present invention, a comprehensive facility performance measure corresponding to domestic conditions and an actual state is defined through analyzing foreign advanced asset management concepts and techniques and a performance measure for quantification of the comprehensive facility performance measure is set. Also, generalized customer value items and properties are defined to evaluate the performance of various facilities of infrastructure and to relatively compare the same.

FIG. 11 is a view illustrating definitions of customer value items when a facility of infrastructure is a bridge in the infrastructure performance evaluation system according to a detailed embodiment of the present invention.

Referring to FIG. 11, to evaluate performance of infrastructure according to the embodiment of the present invention, the customer value items of the infrastructure are classified into 1) sustainability, 2) accessibility, 3) affordability, 4) quality, 5) health & safety, 6) reliability & responsiveness, and 7) customer service and respective properties are defined, thereby deriving ideal comprehensive facility performance measures for each facility of the infrastructure.

Also, 21 types of the facility performance measure described above are defined and the respective facility performance measures are evaluated at separate element or group levels and classified into measures which change with time and measures determined by current levels.

Also, a determination reference is set to qualitatively or quantitatively evaluate the facility performance measures described above, and an alternative which may cause a change in the comprehensive facility performance measures is provided. According to the reference described above, a rating determination reference of each of the performance measures is divided into a five-point scale to provide a basic rating standard. It is necessary to provide reasonable guidelines for the rating standard described above but a large amount of time and effort is needed.

Accordingly, the rating standard for each of the performance measures may be quantitatively provided as much as possible by referring to currently available related guidelines and a performance measure actually applicable may be provided in consideration of practicality. Also, to integrate the facility performance measures with different properties of the comprehensive facility performance measures and to sequence the rating standards of the five-point scale, a basic performance measure utility function is developed using the MAUT. Also, a weight for each of the performance measures is determined using the AHP and a comprehensive performance measure of a bridge is evaluated in connection with the utility function.

An infrastructure asset management system according to one embodiment of the present invention and an existing infrastructure maintenance and management system mutually have a close interrelation and are not mutually independent systems but may be mutually connected. Through a process of checking conditions, a performance history, and a life cycle cost of the infrastructure and estimating future costs, an optimal alternative is to be selected among virtual measures (alternatives of maintenance and management) in an aspect of cost-efficiency or economy.

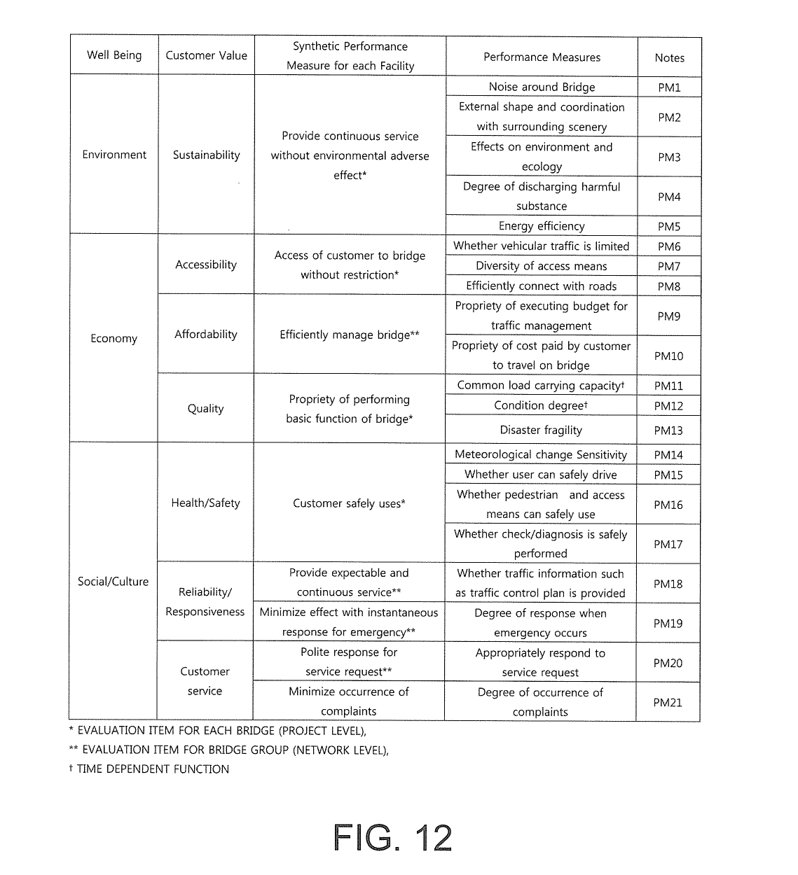

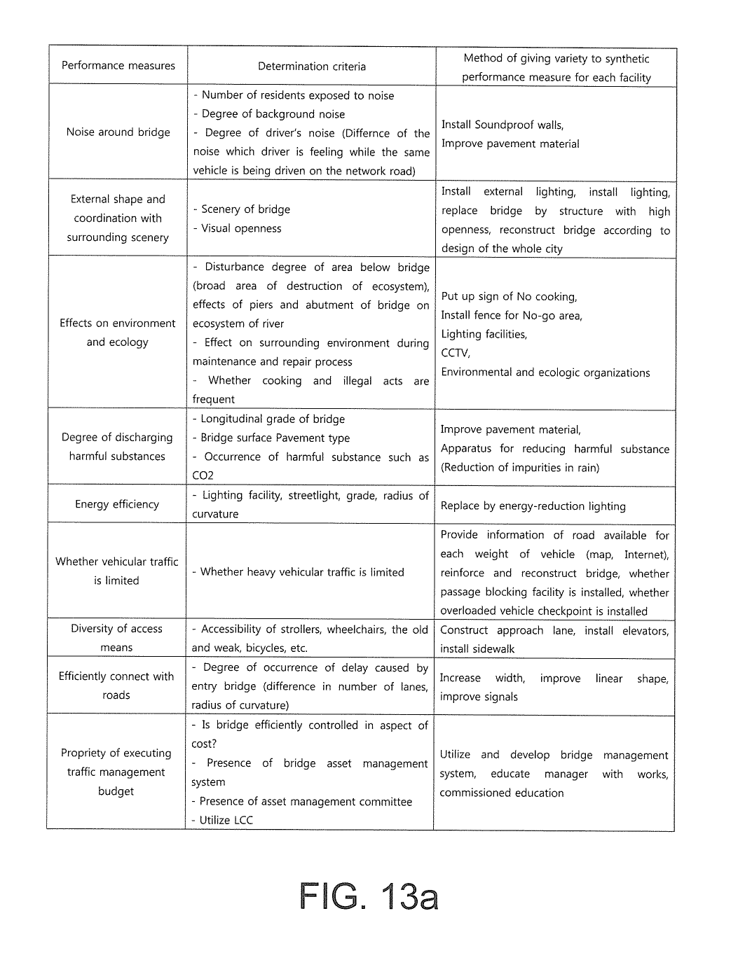

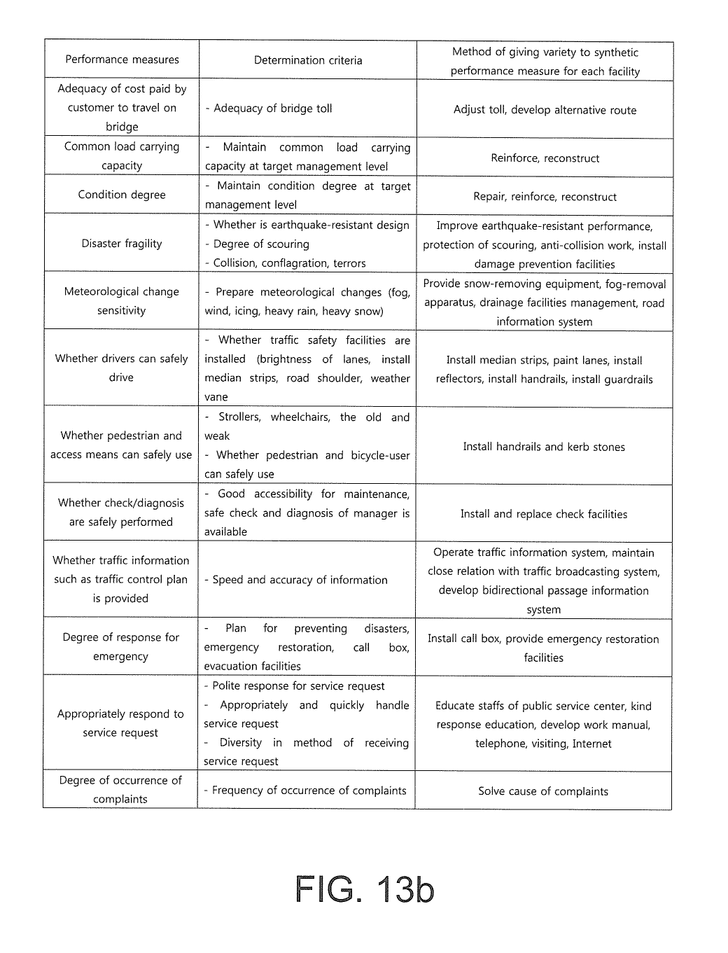

FIG. 12 is a view illustrating facility performance measures according to comprehensive facility performance measures when the facility of infrastructure is the bridge in the infrastructure performance evaluation system according to a detailed embodiment of the present invention. FIGS. 13a and 13b are views illustrating standards for determining facility performance measures according to comprehensive facility performance measures when the facility of infrastructure is the bridge in the infrastructure performance evaluation system according to the detailed embodiment of the present invention.

Referring to FIG. 12, in the infrastructure performance evaluation system according to the detailed embodiment of the present invention, to efficiently and reasonably manage bridge assets, seven customer values related to the comprehensive facility performance measures are defined as described above as facility performance measures for evaluating comprehensive facility performance measures in the embodiment. Here, respective customer values are connected with the comprehensive facility performance measures, the facility performance measures, and evaluation references for evaluating the performance measures described above.

Here, scoring of each of the facility performance measures is determined through consultation of experts and each measure is divided into a five-point scale. In detail, classification of the facility performance measures is performed while the uppermost level theme is classified into “environment”, “economy”, and “society/culture” and each theme is subdivided into customer values. 21 types of facility performance measures to evaluate the customer values for each theme are defined as shown in FIG. 12. Here, the facility performance measures shown in FIG. 12 include all items considerable with respect to the bridge that is a facility to be evaluated with assets thereof in the embodiment of the present invention and sensitivity for each measure may depend on an evaluation method.

The facility performance measures shown in FIG. 12 are classified into items capable of being evaluated for each bridge and items capable of being evaluated as the entire bridge group to be evaluated and may be classified into items of a temporal function and time-invariant items. Here, a function which varies with time means that a performance measure changes as common use years increase, which needs routine maintenance and management. A time-invariant function means that an evaluation rating is determined depending on a bridge design and a bridge group but does not vary with time, in which a performance evaluation score is changed through particular measures.

As shown in FIG. 12, appropriate determination references are necessary to quantitatively determine the performance measures for the bridge and it is necessary to previously consider an available method capable of changing the references. The determination reference for each of the performance measures for the bridge and the method of capable of changing the comprehensive facility performance measures will be described with reference to FIGS. 13a and 13b.

As described above, it is preferentially necessary to establish the comprehensive performance measures for each target facility provided in infrastructure and facility performance measures as measures for quantitatively evaluating the same.

In the embodiment of the present invention, the comprehensive performance measures for the bridge assets are set, the facility performance measures for evaluating the same are determined, and a procedure for objective and quantitative evaluation is constantly provided. This is to more clearly express an evaluation of each facility performance measure in detail based on quantitative standards.

As shown in FIGS. 13a and 13b, development of an asset management technique and available relevant evaluation standards to quantitatively evaluate all 21 performance measures obtained by other studies for increasing performance and use efficiency of the bridge are shown. Also, as shown in FIGS. 13a and 13b, it has been analyzed that relevant references for quantitatively evaluating each facility performance measure are provided but there are some performance measures present to which only qualitative determination references can be applied. Also, a shortage of detailed references for quantitatively evaluating each of the performance measures is present. For example, in performance measures such as a noise around the bridge, even though a certain noise reference (dB) is determined to be a rating of “C” which is intermediate, it is necessary to establish more detailed references for differences among ratings to determine ratings of “A”, “E”, etc.

Also, as an example capable of quantitatively evaluating facility performance measures, a condition rating of the bridge may be provided. The condition rating of the bridge may utilize detailed guidelines for facility safety diagnosis and may calculate an evaluation of conditions of a unit bridge as quantitative ratings by adding up condition evaluation results of separate members.

Also, when it is possible to express an evaluation result of each performance measure as a quantified objective measure, it is determined that a comprehensive performance measure for each performance measure may be derived utilizing the utility function according to the embodiment of the present invention. While the utility function described is developed, it is necessary to determine the utility function by fully considering a bridge to be managed through bridge asset management, a management target level, and an opinion of an expert group.

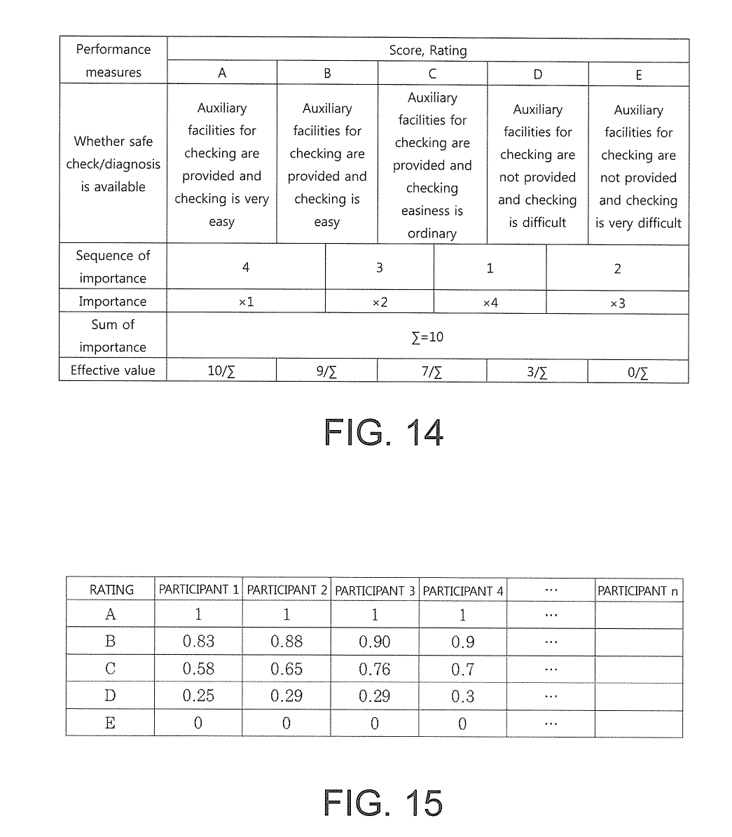

Meanwhile, FIG. 14 is a view illustrating weights for facility performance measures when the facility of infrastructure is the bridge in the infrastructure performance evaluation system according to the exemplary embodiment of the present invention.

Through this process, a utility value may be calculated according to a rating obtained by a facility safety diagnosis result. As shown in FIG. 14, a value of each performance measure allows a comprehensive performance measure of a target bridge to be quantitatively derived by considering a weight for each performance measure.

A comprehensive performance measure score and weight analysis for each facility from a viewpoint of a customer and a viewpoint of a manager may be calculated by analyzing the AHP, thereby making a decision in a direction of reducing a gap through analyzing a mutual gap. For example, a social/cultural weight may be considered to be high from the viewpoint of the customer but an economic or environmental weight may be considered to be high from the viewpoint of the manager. Also, it is necessary to overcome a difference caused by a gap.

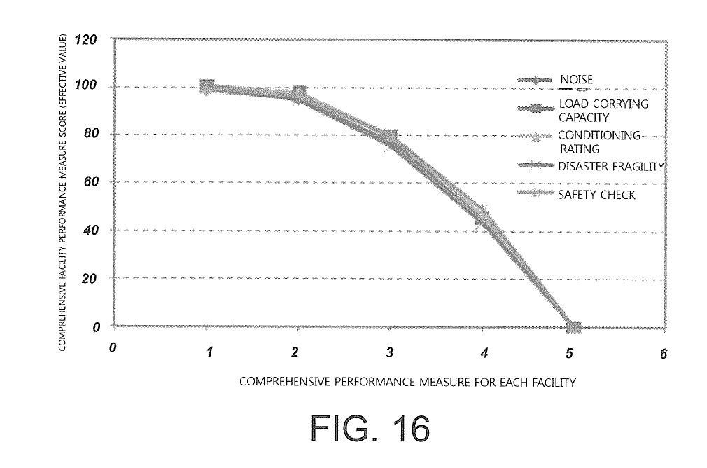

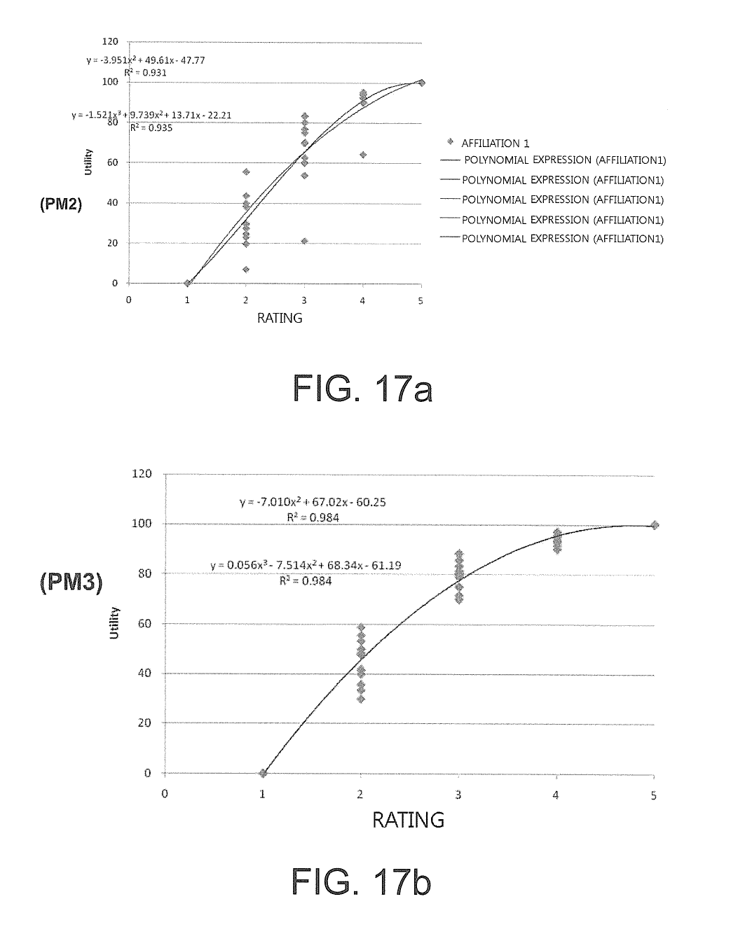

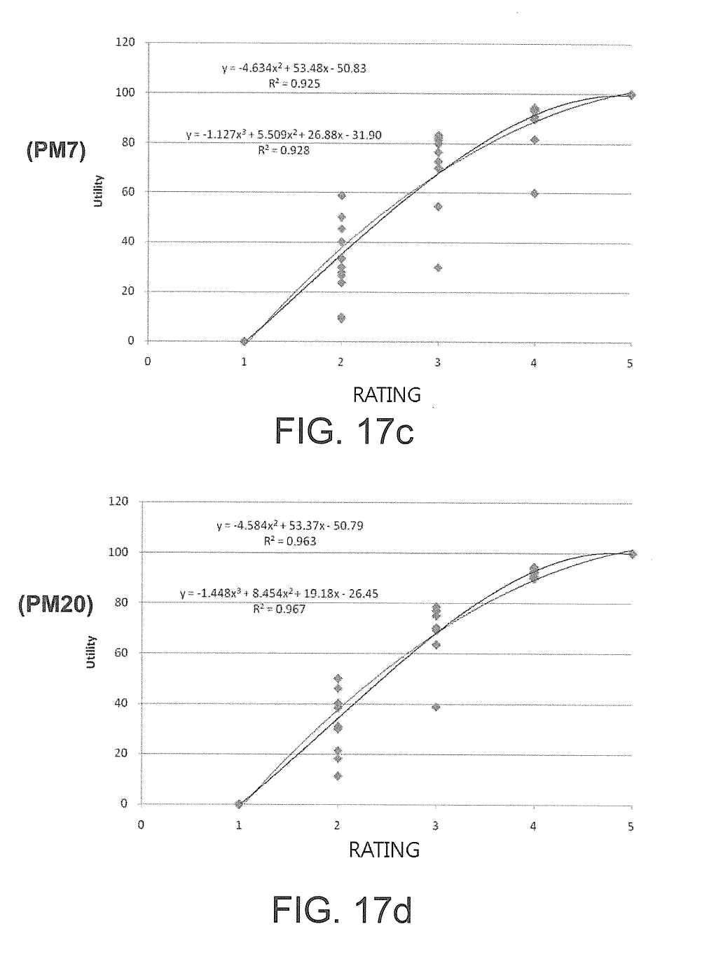

FIG. 15 is a view illustrating a result of a survey for determining a utility function when the facility of infrastructure is the bridge in the infrastructure performance evaluation system according to the exemplary embodiment of the present invention. FIG. 16 is a view illustrating comprehensive performance measure scores (effective values) for each of facilities according to comprehensive performance measure ratings for each facility when the facility of infrastructure is the bridge in the infrastructure performance evaluation system according to the exemplary embodiment of the present invention. FIGS. 17a to 17d are views illustrating utility values of facility performance measures when the facility of infrastructure is the bridge in the infrastructure performance evaluation system according to one embodiment of the present invention, respectively.

The utility function for each performance measure is determined in the infrastructure performance evaluation system according to the detailed embodiment of the present invention as follows.

A comprehensive performance rating (comprehensive performance measure) of each of facilities of infrastructure, for example, the bridge to be evaluated may be determined using a value quantified by applying the MAUT. Here, the MAUT may be effectively utilized during a process of making a decision in consideration of a plurality of references. When the MAUT described above is utilized, both partial properties and total properties may be considered with respect to a comprehensive performance measure having various properties.

Accordingly, in the embodiment of the present invention, various facility performance measures for evaluating a comprehensive performance rating (comprehensive performance measure) of the bridge are considered and a relative desirability of each facility performance measure is considered to ultimately express a quantitative comprehensive performance rating (comprehensive performance measure).

To evaluate this, a single attribute utility function for each performance measure is determined first, which indicates a correlation between a change in rating and an effective value in a single facility performance measure. To determine it, an order of importance in changes of respective performance measure ratings, that is, E→D, D→C, C→B, B→A may be determined according to preference. Among the respective changes in rating, compared with a case of lowermost importance thereof, importance of other changes in rating may be determined as a relative value.

In the embodiment of the present invention, the respective facility performance measures are divided into five stages as shown in FIG. 14. It is assumed that E (very bad) which is the lowest rating and A (very good) which is the highest rating have effective values of 0% and 100%, respectively. A change in importance according to each change in rating is expressed as following Equation 1, in which merely, it is assumed that a change from the rating of E to a rating of D has the lowermost importance.

uᵢ(x_{iA})−uᵢ(x_{iB})=α[uᵢ(x_{iD})−uᵢ(x_{iE})]

uᵢ(x_{iB})−uᵢ(x_{iC})=β[uᵢ(x_{iD})−uᵢ(x_{iE})]

uᵢ(x_{iC})−uᵢ(x_{iD})=γ[uᵢ(x_{iD})−uᵢ(x_{iE})] Equation 1

Three simultaneous equations formed described above are solved to determine a utility value. Here, x_{iA} indicates a rating of an ith performance measure, a uᵢ value indicates an effective value of a certain rating of A to E of the ith performance measure, α, β, and γ indicate relative importance values of other change in rating based on a change in rating of the lowermost importance. Accordingly, values of uᵢ(x_{iB}), uᵢ(x_{iC}), and uᵢ(x_{iD}) may be determined by solving the above three simultaneous equations.

In the embodiment of the present invention, a survey was performed to determine a utility function for each performance measure described above. FIG. 15 exemplarily illustrates the survey for determining the utility function for each performance measure described. Through the process described above, a single attribute utility function of the ith performance measure may be determined.

In detail, to obtain the utility function for each performance measure, the survey was performed with bridge management experts for each research team on respective items. To determine a utility function for each performance measure of a general facility of infrastructure, a survey may be conducted with a customer group. However, for an aspect of the embodiment of the present invention, the customer group was excluded from the survey. FIG. 15 illustrates a result of the survey, and FIG. 16 illustrates a utility function of each performance measure.

Also, FIGS. 17a to 17d illustrate the utility function for each performance measure, which is expressed as secondary and tertiary curves through regress analysis using the survey result. For example, FIG. 17a illustrates a utility function with respect to coordination between an external shape and surrounding scenery, FIG. 17b illustrates a utility function with respect to effects on environment and ecology, FIG. 17c illustrates a utility function with respect to variety of access means, and FIG. 17d illustrates a utility function with respect to an appropriate response for a request for service.

In part of a survey result, a great change was shown between collected materials. However, due to an assumption in which effective values of the highest rating A and the lowest rating E are 100% and 0%, respectively, a correlative coefficient R2 is shown relatively high. In detail, in FIGS. 17a to 17d, for expression in a graph, the rating A is shown as 5 and the rating E is shown as 1. Here, in most performance measures, relatively great effective values are shown in changes among lower ratings (E→D or D→C) and an effective value of a change between the ratings B→A is shown to be lowest.

Meanwhile, a comprehensive performance measure provided by the bridge to be evaluated may be evaluated for each bridge group, each bridge, and each performance measure and then the utility theory may be grafted to develop the utility function for each performance measure to quantitatively evaluate a comprehensive performance measure for each bridge. After a weight to be assigned to each performance measure is determined, the comprehensive performance measure of each bridge to be evaluated may be shown as a quantified value using a product of a utility value and the determined weight.

Also, a level of the rating of the facility performance measure may be expressed as following Equation 2.

Level=Σkᵢ×uᵢ(xᵢ) Equation 2

The level of the rating is determined through Equation 2. Here, kᵢ indicates a weight for each performance measure and uᵢ(xᵢ) indicates a function value for each performance measure.

In other words, to evaluate the comprehensive performance measure for each bridge by applying the MAUT, it is necessary to determine the weight for each performance measure and to obtain a product of the weight and the utility value for each performance measure as shown in Equation 2.

Accordingly, in the embodiment of the present invention, to determine the weight for each facility performance measure, the AHP technique was to be utilized. The weight for each performance measure in Equation 2 may be determined by dividing the comprehensive performance measures for each customer value and for each facility and each facility performance measure into hierarchies using the AHP technique developed by Saaty and comparing comparison items for each hierarchy may be determined by utilizing a pairwise comparison method. The AHP is a method of calculating the importance of each alternative by dividing and checking a weight between target values into hierarchies.

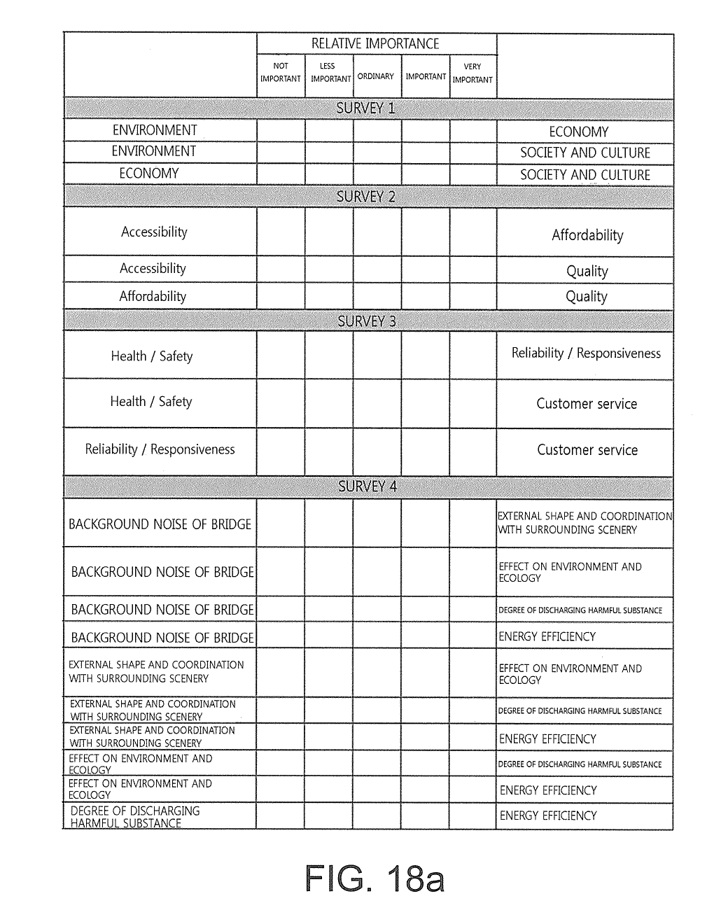

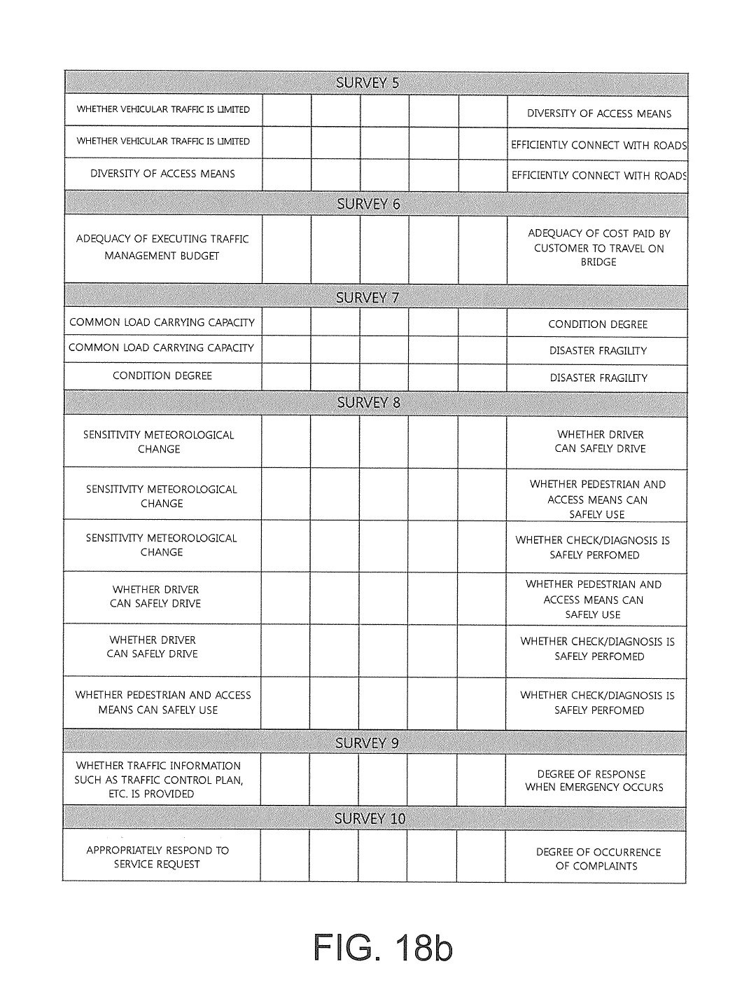

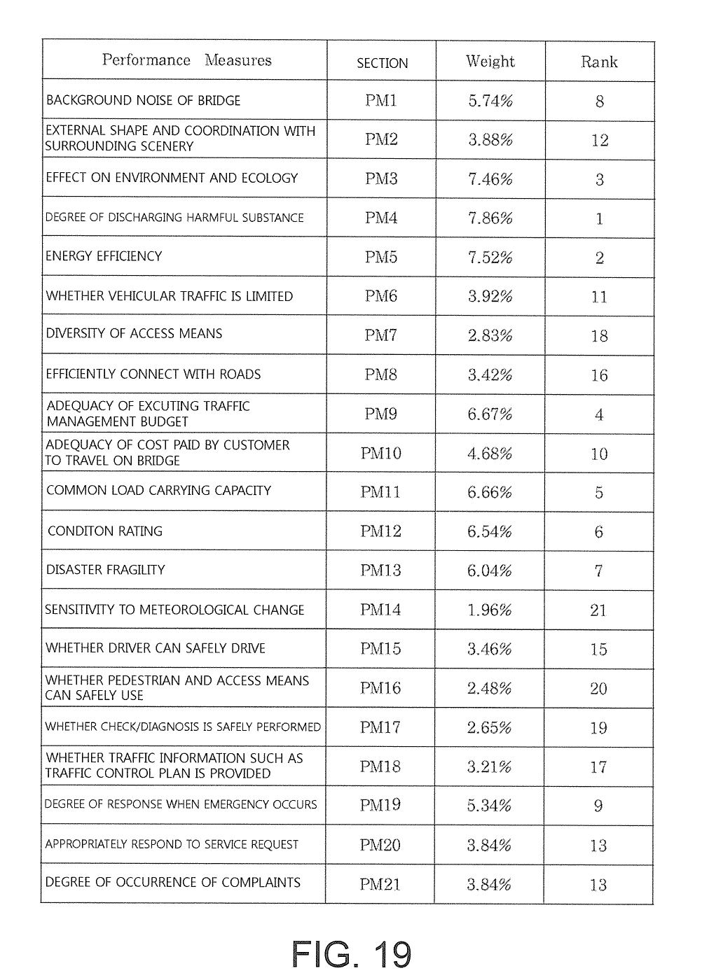

FIGS. 18a to 18b are views illustrating questionnaires for determining weights when the facility is the bridge in the infrastructure performance evaluation system according to one embodiment of the present invention, respectively. FIG. 19 is a view illustrating a result of a survey for determining weights when the facility is the bridge in the infrastructure performance evaluation system according to one embodiment of the present invention.

As shown in FIGS. 18a and 18b, to evaluate performance of infrastructure, importance was determined through pairwise comparison with respect to items for each theme, each customer value, and performance measure. For this, a survey was conducted targeting the same expert group as the group of the survey for determining the utility function. In the embodiment of the present invention, the survey was merely conducted while relative importance in each comparison is based on a five-point scale. FIGS. 18a and 18b illustrate examples of the questionnaires for determining weights. A result of the survey for determining weights is shown in FIG. 19.

After all, according to the embodiment of the present invention, a condition rating according to a result of a survey targeting experts is expressed as a sequentially distributed probability distribution function using a fuzzy membership function and a comprehensive performance measure score is more accurately expressed as a probability distribution function, thereby accurately evaluating a comprehensive performance measure rating. Also, a utility value is derived using a utility function and usable and functional evaluation measures for each facility of infrastructure are collected, thereby comprehensively determining subjective performance evaluation measures of infrastructure.

According to the embodiment of the present invention, a condition rating according to a result of a survey targeting experts is expressed as a sequentially distributed probability distribution function using a fuzzy membership function and a comprehensive performance measure score is more accurately expressed as a probability distribution function, thereby accurately evaluating a comprehensive performance measure rating.

Also, a utility value is derived using a utility function and usable and functional evaluation measures for each facility of infrastructure are collected, thereby comprehensively determining subjective performance evaluation measures of infrastructure

Although a few embodiments of the present invention have been shown and described, it would be appreciated by those skilled in the art that changes may be made in these embodiments without departing from the principles and spirit of the invention, the scope of which is defined in the claims and their equivalents. Therefore, it will be understood that the embodiments described above are just exemplary and not limitative in all aspects. For example, each element described as a single type may be executed while being distributed and likewise elements described as being distributed may be executed in a coupled state.

The scope of the present invention will be defined by the following claims rather than the above description and it will be understood that all modifications and modified forms derived from the concept and the scope of the claims and equivalents thereof are included in the scope of the present invention.

What is claimed is:

1. A system for evaluating the performance of infrastructure which comprises roads, railways, harbors, dams, bridges, airports, rivers, water supplies, and fishing ports, the system comprising:
a comprehensive facility performance measure setting unit (110) which selects a comprehensive performance measure for each facility, which is defined according to customer value items preset for each facility of the infrastructure;
a facility performance measure setting unit (120) which defines a facility performance measure which quantitatively indicates the comprehensive facility performance measure for each facility of the infrastructure using a fuzzy membership function according to properties of the comprehensive facility performance measure;
a facility performance measure utility function determination unit (130) which determines a utility function for each facility performance measure corresponding to an effect value selectively given within a range from 0% to 100% utilizing an expert survey through normalization using a utility theory;
a facility performance measure weight determination unit (140) which assigns a weight for each facility performance measure using an analytic hierarchy process (AHP);
a facility performance measure evaluation unit (150) which evaluates the facility performance measure utilizing an on-site survey or a check result;
a facility performance measure utility function determination unit (160) which determines a utility value for each facility performance measure using the determined facility performance measure utility function and the assigned weight;
a facility comprehensive performance measure score calculation unit (170) which calculates a facility comprehensive performance measure score for each facility of the infrastructure;
a facility comprehensive performance measure evaluation result analysis unit (180) which analyzes an evaluation result by analyzing an effect of the facility performance measure on the facility comprehensive performance measure score; and
an infrastructure performance evaluation unit (190) which performs a comprehensive performance evaluation for each facility of the infrastructure,
wherein the facility performance measure setting unit (120) expresses a condition rating according to a result of the expert survey using the fuzzy membership function as a sequentially distributed probability distribution function, and corresponding thereto, the facility comprehensive performance measure is expressed as a probability distribution function in the form of a fuzzy membership function.

2. The system of claim 1, wherein the fuzzy membership function is a fuzzy membership function with a strengthened central score.

3. The system of claim 1, wherein the facility performance measure setting unit (120) classifies the customer value items of the infrastructure into sustainability, accessibility, affordability, quality, health & safety, reliability & responsiveness, and customer service and defines respective properties to derive comprehensive infrastructure performance measures.

4. The system of claim 1, wherein the facility performance measure utility function determination unit (130) selectively determines the utility function for each performance measure within a range from 0% to 100% according to a multi-attribute utility theory (MAUT) to integrate facility performance measures with different properties of the comprehensive facility performance measure and to sequence a rating standard.

5. The system of claim 1, wherein the facility performance measure utility value determination unit (160) determines the utility value by solving three simultaneous equations formed of
uᵢ(x_{iA})−uᵢ(x_{iB})=α[uᵢ(x_{iD})−u(x_{iE})]
uᵢ(x_{iB})−uᵢ(x_{iC})=β[uᵢ(x_{iD})−u(x_{iE})]
uᵢ(x_{iC})−uᵢ(x_{iD})=γ[uᵢ(x_{iD})−u(x_{iE})] Equation 1
in which x_{iA} indicates a rating of an ith performance measure, a uᵢ value indicates an effective value of a certain rating of A to E of the ith performance measure, α, β, and γ indicate relative importance values of other change in rating based on a change in rating of the lowermost importance.

6. The system of claim 5, wherein a level of the rating is determined through Level=Σkᵢ×uᵢ(xᵢ), in which kᵢ indicates a weight for each performance measure and uᵢ(xᵢ) indicates a function value for each performance measure xᵢ.

7. The system of claim 1, wherein the facility comprehensive performance measure evaluation result analysis unit (180) analyzes an effect of the facility performance measure on the facility comprehensive performance measure score and resets a facility performance measure according to analysis of an evaluation result and a maintenance and management strategy.

8. A method of evaluating the performance of infrastructure which comprises roads, railways, harbors, darns, bridges, airports, rivers, water supplies, and fishing ports, the method comprising:
a) selecting a comprehensive performance measure for each facility, which is defined according to customer value items preset for each facility of the infrastructure;
b) defining a facility performance measure which quantitatively indicates the comprehensive facility performance measure for each facility of the infrastructure using a fuzzy membership function according to properties of the comprehensive facility performance measure;
c) determining a weight for each facility performance measure using an AHP;
d) determining a utility function for each facility performance measure corresponding to an effect value selectively given within a range from 0% to 100% utilizing an expert survey through normalization using a utility theory;
e) evaluating the facility performance measure utilizing an on-site survey or a check result;
f) determining a utility value for each facility performance measure using the determined facility performance measure utility function and the determined weight;
g) calculating a facility comprehensive performance measure score for each facility of the infrastructure;
h) analyzing an evaluation result by analyzing an effect of the facility performance measure on the facility comprehensive performance measure score; and
i) performing a comprehensive performance evaluation for each facility of the infrastructure,
wherein in operation b), a condition rating according to a result of the expert survey is expressed using the fuzzy membership function as a sequentially distributed probability distribution function, and corresponding thereto, the comprehensive performance measure for each facility is expressed as a probability distribution function in the form of a fuzzy membership function.

9. The method of claim 8, wherein the fuzzy membership function is a fuzzy membership function with a strengthened central score.

10. The method of claim 8, wherein operation a) comprises:
classifying the customer value items of the infrastructure into sustainability, accessibility, affordability, quality, health & safety, reliability & responsiveness, and customer service; and
defining respective properties to derive comprehensive infrastructure performance measures.

11. The method of claim 8, wherein the utility function for each performance measure is selectively determined within a range from 0% to 100% according to an MAUT to integrate facility performance measures with different properties of the comprehensive facility performance measure and to sequence a rating standard.

12. The method of claim 8, wherein in operation f), the utility value is determined by solving three simultaneous equations formed of
uᵢ(x_{iA})−uᵢ(x_{iB})=α[uᵢ(x_{iD})−uᵢ(x_{iE})]
uᵢ(x_{iB})−uᵢ(x_{iC})=β[uᵢ(x_{iD})−u_{iD}(x_{iE})]
uᵢ(x_{iC})−uᵢ(x_{iD})=γ[uᵢ(x_{iD})−u_{iD}(x_{iE})] Equation 1
in which, x_{iA} indicates a rating of an ith performance measure, a uᵢ value indicates an effective value of a certain rating of A to E of the ith performance measure, α, β, and γ indicate relative importance values of other change in rating based on a change in rating of the lowermost importance.

13. The method of claim 12, wherein a level of the rating is determined through Level=Σkᵢ×uᵢ(xᵢ), in which kᵢ indicates a weight for each performance measure and uᵢ(xᵢ)indicates a function value for each performance measure xᵢ.

14. The method of claim 8, wherein in operation h), an effect of the facility performance measure on the facility comprehensive performance measure score is analyzed and a facility performance measure is reset according to analysis of an evaluation result and a maintenance and management strategy.
